(19) United States
(12) Patent Application Publication
(10) Pub. No.: US 2013/0019150 A1
(43) Pub. Date: Jan. 17, 2013

(54) SYSTEM AND METHOD FOR AUTOMATIC AND DYNAMIC LAYOUT DESIGN FOR MEDIA BROADCAST

(71) Applicant: Rony ZAROM, New York, NY (US)

(72) Inventor: Rony ZAROM, New York, NY (US)

(21) Appl. No.: 13/212,368

(22) Filed: Aug. 18, 2011

Related U.S. Application Data
(60) Provisional application No. 61/507,447, filed on Jul. 13, 2011.

(51) Int. Cl. G06F 17/00

(52) U.S. Cl. 715/204

(57) ABSTRACT

A system, device and method for automatic layout design. A first set of media objects may be displayed in a broadcast within a first layout. A request may be received to change the first set of media objects to a second set of media objects to be displayed in the broadcast. A plurality of different candidate layouts may be provided, wherein each of the different candidate layouts is predefined to display a different set of media objects. A second layout may be selected from among the plurality of different candidate layouts, where the second layout is predefined to display the second set of media objects. The second set of media objects may be displayed in the broadcast within the second layout. In some embodiments, the displayed layout may be switched from the first layout to the second layout in real-time, for example, as the request is received.

### REFERENCE TO RELATED APPLICATION

This application claims the benefit of U.S. Provisional Patent Application Ser. No. 61/507,447, filed Jul. 13, 2011, entitled “System and Method for Automatic and Dynamic Layout Design for Media Broadcast”, which is incorporated herein by reference in its entirety.

### FIELD OF THE INVENTION

The present invention relates to systems and methods for providing and operating dynamic layout design, for example, to accommodate a dynamic influx of media objects for real-time broadcasting.

### BACKGROUND OF THE INVENTION

Broadcasts for news or media shows or for personal use may stream multiple video, audio, and/or text objects, simultaneously, in separate embedded media windows. Such broadcasts can occur via standard broadcast format, e.g., on a monitor display, or via Internet, e.g., in a webpage. Typically the layout design defining the spatial arrangement of media windows on a monitor or in the webpage is fixed by the broadcast layout or by a webpage creator and is difficult to change, for example, by re-programming the broadcast layout or webpage.

However, media objects in a broadcast may not be fixed, but instead may change dynamically throughout the broadcast. For example, the numbers of videos to be broadcast simultaneously may change over time. Fixed media window arrangements may be unable to accommodate such a dynamic influx of media objects. For example, if the broadcast monitor, display or webpage includes fewer media windows than the number of input media, the broadcast or display of the extra media may be delayed or cut, while if the monitor, display or webpage includes more media windows than the number of input media, the extra windows may remain empty resulting in “dead air” or “dead space” where no content is broadcast.

There is a need in the art for dynamic layout design to accommodate dynamic broadcast content.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings. Specific embodiments of the present invention will be described with reference to the following drawings, wherein:

FIG. 1 is a schematic illustration of a system for automatic and dynamic layout design in accordance with an embodiment of the invention;

FIG. 2 is a flowchart illustration of a method automatic and dynamic layout design in accordance with an embodiment of the invention; and

FIGS. 3-6 are examples of layout interfaces for operating a system and method for automatic and dynamic layout design in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

“Broadcast” may mean any display, stream or presentation of any medium, such as, image, videos, multi-media, audio, text, etc. Broadcasts may be provided via any public or private media channel, for example, a wired or wireless channel or network such as the Internet, television, closed-circuit television, radio, on a user's computer, etc. Broadcasts may be displayed on any output device, such as a television screen, personal computer monitor, wireless device monitor, cellular phone monitor, tablet computer monitor, radio player, etc. Broadcasts may use any personal or collaborative viewing platform including webinars, synchronized media displays for a collection of viewers, etc. In some embodiments herein, Internet broadcast is described as an example and may refer to any other type of broadcast of streaming display.

Broadcasts may include complex combinations of media objects, for example, including, one or more images, videos, audio tracks, text streams, social media or chat streams, embedded webpages, advertisements, etc. As the different media objects that are continually being streamed for broadcast are changed, the number, size, type and display layout of media windows used to display these objects may also change to accommodate and conform to the new number, size and type of media input.

In one example, a display device may receive multiple videos for broadcast, each having different overlapping playtimes (e.g., different start times, durations, and/or end times). Accordingly, the number of videos to be simultaneously displayed may change over time and, thus, so too may the number of video windows in the display. The display may be adapted to have, at any instant, a display layout incorporating the same number, type and format of media windows in which to display content to match the content objects that are to be displayed. By dynamically changing the number of display windows to match the changing number of content objects, and by changing the display layout design to match the number of display windows needed, as well as the types and formats of media being broadcast within those windows, broadcast displays may avoid having layouts that are ill-suited for the display of the specific numbers, types and formats of media being displayed or broadcast within the windows. For example, dynamic broadcast displays may avoid having too few display windows (e.g., delaying broadcast of the extra content objects), too many display windows (e.g., in which no content or “dead air” may be broadcast in the extra windows), display windows for similar content that are not sized or set out appropriately, etc.

In order to allow the broadcast layout design to dynamically change so as to conform to media input, a layout design database may include a plurality of different, predetermined, alternate designs, layouts, or themes, each conforming to a different set of input media parameters. When the layout mechanism or processor detects a change in input objects, the layout mechanism or processor may automatically search for a design layout that is appropriate for the new content parameters of the media input and switch between layout designs to match the changed content parameters of the input media. Receiving a new media object (or a request to display a new media object) may trigger the layout mechanism or processor to search for and switch to a new layout. Each different layout design may include a background layer design (e.g., wallpaper, icons, colors, etc.), a media object (middle layer) design (e.g., types, formats and numbers of media windows, spatial position, size and/or aspect ratios of media windows, hierarchy or order of importance of media windows, etc.), and/or a foreground layer design (e.g., user interface, layering of objects, finishing texture, luminescence or translucency, etc.). The broadcast client or manager may personalize its layout designs, e.g., by customizing the background layer of all its layouts, or may use default designs.

A relational map may define correspondences between the plurality of different combinations of input media objects or associated parameters and the plurality of different alternate layout designs. For example, in one embodiment, the relational map may include a plurality of layout designs (e.g., A, B, C, . . . ), each of which corresponds to a unique identifier (e.g., sequences of bits 00100, 01001, 11001, . . . , respectively). Each identifier may represent a different combination of input objects (e.g., bits 1−N defining if the input includes 1−N video objects, respectively, ((1)=yes; (0)=no); the N+1 bit defining if the input includes a chat stream object ((1)=yes; (0)=no); the N+2 bit defining if the input includes a text banner object ((1)=yes; (0)=no); etc.). Further identification may be provided for the object parameters, such as, aspect ratios, colors, display priority or window preference, etc. Any other means of creation of a relational database, table or map associating each of the plurality of different combinations of input media objects or associated parameters with one of the plurality of different alternate layout designs, as is well known in the art, may be used.

When the layout mechanism or processor receives an indication of a change in media objects (e.g., to add, delete, or replace media objects), the layout mechanism or processor may search the relational database map or look-up table for a matching identifier and, if found, may implement the associated layout design to display the changed media objects. The correspondences between layouts and sets of media objects (or their associated identifiers) may be one-to-one (e.g., each unique combination of media objects may be viewed via a unique layout design), one-to-many (e.g., each unique combination of media objects may have a variety of layout designs selected for display by a broadcaster, user or via an automated system monitoring user preferences), or many-to-one (e.g., multiple different arrangements of input media objects may be adapted for viewing in a single layout design). If multiple designs satisfy a set of parameters, a broadcaster may have the option to select a single favorite design. In some embodiments, the multiple designs may be provided with different priority, for example, ordered from a best-fit to a worst-fit.

Different layout designs or themes may be linked, not only to different combinations of input media objects, but also to different output devices. For example, the layout for a cell phone display may be different from the layout for a computer screen, due to the difference in the size and aspect ratios of the cell phone display and screen. In one example, the layout database may include a unique set of layout designs for each of a plurality of different display aspect ratios, specifically designed to optimize visibility of media objects on that display.

These dynamic layouts may be used for real time media broadcasting. In conventional systems, a broadcaster has a fixed number of media windows in which to display content, restricting his choice of media to a fixed number of objects. If the broadcaster wanted to change the number of media windows, he/she would need to manually create or program such a change, which is impractical for real time broadcasting. According to embodiments of the invention, when broadcasting, there is already a pre-determined layout for each combination of media objects, so that a broadcaster may freely add, delete, swap and replace media objects, seamlessly, in real time. As the broadcaster changes the input objects over time (or as the media objects change themselves, such as, when a video ends), the layout mechanism or processor may automatically change layouts, e.g., as defined by the layout relational database map, for real time dynamic layout design.

A layout interface may be provided for interacting with the broadcast designer, for example, to receive media objects from the broadcaster and to simulate a real-time broadcast for the broadcaster to view. The layout interface may include a broadcast screen, a staging or “green room” screen, and/or a media database, although other screens or interfaces may be used. The media database may be a repository or archive of media objects from which the broadcaster may select for display (e.g., by dragging a thumbnail of the object from the media database interface to the broadcast screen). The broadcast screen may include a representation or simulation of the display windows as they are arranged when broadcast to a user. Each window may display the selected media objects, e.g., based on the order in which they are selected, based on a priority, either predetermined or set by the broadcaster, or based on a specific designation of each object to a specific window. Adding a new window or deleting a window may trigger a process to select a new layout predetermined for the greater or the fewer number of windows, respectively, depending upon the type and format of media content to be displayed in that window. Some interfaces may include a staging screen, which may mimic the broadcast screen, for example, to prepare a broadcast “off-air,” but only implement the broadcast once an “on-air” signal is sent.

The broadcast system may implement automated layout design operations, for example, ADD, DELETE, SWAP and REPLACE media windows. The layout operations may be responsive to client controls, for example, automatically reconfiguring the broadcast layout to match the media changes to media, in real-time, for example, as the media is streamed or a request for different media objects is received. An ADD window operation may be triggered, for example, by the broadcaster selecting a new object when all other windows are occupied or by dragging the object to a new location not occupied by another window. A DELETE window operation may be triggered, for example, by the broadcaster dragging the window off of the broadcast screen, e.g., to a trash icon, or by selecting a “delete” button for the window to be deleted. A REPLACE window operation may be triggered, for example, by the broadcaster dragging the frame of one window to the location of the other, by reordering the windows in a hierarchy key—each number correlated to a spatial location on the broadcast display, or by selecting a replace button for the window to be replaced or to doing the replacing. A SWAP (i.e., content swap) operation may be triggered, for example, by the broadcaster dragging the content image of one window to the location of the other, or by selecting a “swap” content button for the windows whose locations or positions are to be swapped. Other automated layout operations may be provided, for example, to display the windows in a cycling order creating a montage or slideshow effect, to merge windows or embed one window in another, etc.

In some embodiments of the invention, in addition to or instead of a content SWAP operation, the system may provide a layout SWAP operation. In one example, two windows may stream media objects of different aspect ratios. If a broadcaster swaps the media content of the windows but not the windows themselves, the windows may be improperly sized, i.e., too large or too small, for the respectively swapped media. Accordingly, instead of simply swapping content and keeping the same layout (e.g., a content SWAP), when media objects having different media properties, embodiments of the invention may search for and provide a new layout for the new arrangement of objects (e.g., a layout SWAP). In one embodiment, media may be divided into a plurality of groups based on their media properties (e.g., media type, aspect ratio, resolution, etc.), and a broadcast screen may be divided into a plurality of zones or window positions for different layouts (e.g. a primary window (1) at center, and secondary windows (2, 3, 4, . . . ) surrounding the primary window). Each layout may have a specific configuration of windows, each window being associated with a specific media group for exclusively displaying objects from that group. Accordingly, if an object in a first media group is swapped with an object in a second media group, embodiments of the invention may search for a new layout with the new swapped arrangement of windows and associated media groups. In some embodiments, if a layout is not defined for the new arrangement, the old layout or a new closest layout may be used, and the media objects may be resized to fit those windows.

In some embodiments, layouts may be defined separately for each media group. For example, a screen may have multiple layout layers for each different media group, for example, a video layout, a webcam layout, a presentation layout, etc. Accordingly, if a media object is changed for a specific media group (e.g., 16×9 aspect ratio videos), the layout may be changed only for the associated layout layer without adjusting the other layers for other media groups. By segmenting the broadcast layout into multiple sub-layouts for each different media group, embodiments of the invention may search a smaller database of layouts specific to each media type for each media change, thereby increasing processor speed for selecting layouts.

A broadcast interface may be provided to a user to view the broadcast.

Systems and methods for automated dynamic layout design may be implemented remotely, e.g., at a remote layout server, locally, e.g., via a layout program or plug-in, or using a combination of remote and local devices in communication with each other, e.g., a local plug-in at a user computer providing the user display parameters, such as, a screen aspect ratio, to the remote server to select a layout appropriate for such user parameters.

Although some embodiments of the invention describe automatic dynamic layout for displaying media in an Internet, television, radio or other broadcast, it may be appreciated that such embodiments of the invention may similarly be used for any other type of layout, including, for example, newspaper or magazine layout, text or multi-media layout, combining audio tracks as an automated disk-jockey, or any other system and method for automatically combining dynamic input objects.

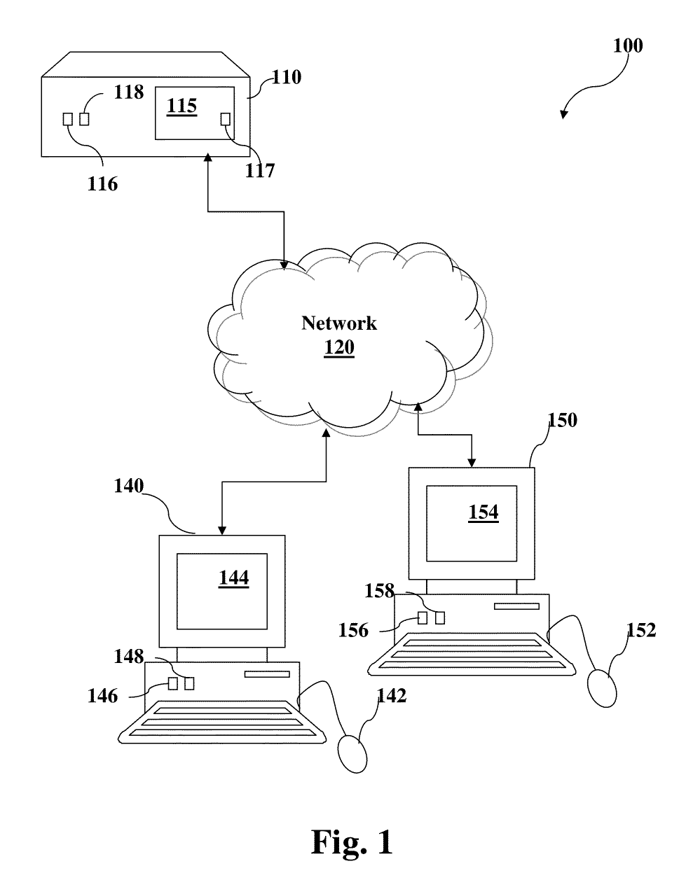

Reference is made to FIG. 1, which schematically illustrates a system 100 for automatic and dynamic layout design in accordance with an embodiment of the invention.

System 100 may include a client device 150 for providing or selecting media for broadcasts, a broadcast device 110 to compile and broadcast media, and a user device 140 to view and/or listen to (“display”) broadcasts, all of which are connected via a network 120 such as a television network, radio network or the Internet. Dynamic layout design may be provided remotely via broadcast device 110 or locally at client device 150 via a program or plug-in. In some embodiments, a separate media server may also be used.

One or more user device(s) 140, e.g., each viewed by a user, may access media broadcasts via network 120 over any media channel, such as, Internet, television, radio, podcasts, etc.

One or more client device(s) 150 may be operated by clients or broadcasters to design media broadcasts.

User device 140 and client device 150 may be personal computers, desktop computers, mobile computers, laptop computers, and notebook computers or any other suitable device such as a cellular telephone, personal digital assistant (PDA), video game console, etc. User device 140 may alternately be a passive output device such as a television, projector, radio, etc. User device 140 and client device 150 may include one or more input devices 142 and 152, respectively, for receiving input from a user. User device 140 may include one or more output devices 144 (e.g., a monitor or screen) for displaying a broadcast to a user hosted by broadcast server 110. Client device 150 may include one or more output devices 154 for displaying to a client a broadcast interface having entry fields and uploading capabilities for designing, selecting and creating broadcasts.

Network 120, which connects broadcast server 110, user device 140 and client device 150, may be any publicly or privately accessible network such as the Internet, television, etc. Access to network 120 may be through wire line, terrestrial wireless, satellite or other systems.

Server 110, user device 140, and client device 150, may include one or more processor(s) 116, 146, and 156, respectively, for executing operations and one or more memory unit(s) 118, 148, and 158, respectively, for storing data and/or instructions (e.g., software) executable by a processor. Processor(s) 116, 146, and/or 156 may include, for example, a central processing unit (CPU), a digital signal processor (DSP), a microprocessor, a controller, a chip, a microchip, an integrated circuit (IC), or any other suitable multi-purpose or specific processor or controller. Memory unit(s) 118, 148, and/or 158 may include, for example, a random access memory (RAM), a dynamic RAM (DRAM), a flash memory, a volatile memory, a non-volatile memory, a cache memory, a buffer, or other suitable memory units or storage units.

Broadcast server 110 may include a computing device for hosting and distributing broadcasts over network 120 according to embodiments disclosed herein. Broadcast server 110 may include applications for interacting with user device 140 and client device 150. Database 115 may store media objects and/or software applications for automatic and dynamic layout designs. Database 115 may store a relational database map 117 or look-up table defining correspondences between layouts and media objects.

Broadcast server 110 may display a first set of media objects in a broadcast with a first layout. Broadcast server 110 may receive a request, for example, from client device 150, to change the first set of media objects to a second set of media objects to be displayed in the broadcast. The request may be to add, delete, replace or swap media objects and/or their display windows in the broadcast. The request may trigger broadcast server 110 to search map 117 for a second layout from among a plurality of different candidate layout designs that is predefined to display the second set of media objects. If the matching layout entry is found, broadcast server 110 may use the second layout to display the second set of media objects in the broadcast, for example, on user device 140. If the matching layout entry is found, broadcast server 110 may send client device 150 an error message indicating that such a layout is not available and/or create a new second layout design.

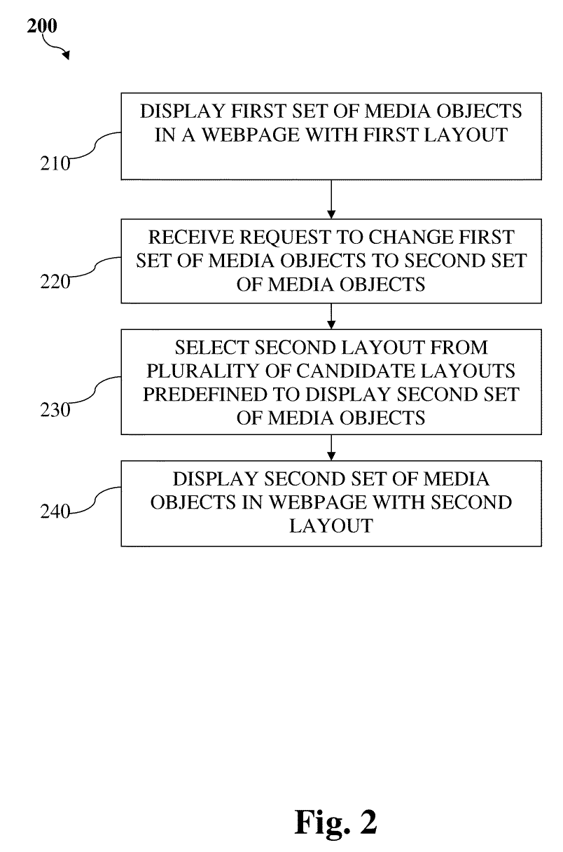

Reference is made to FIG. 2, which is a flowchart 200 of a method in accordance with an embodiment of the invention.

In operation 210, a broadcast may display a first set of media objects in a broadcast with a first theme or layout design. The broadcast may be run via a broadcast server (e.g., from broadcast server 110 of FIG. 1), created via a client device (e.g., from client device 150 of FIG. 1), and displayed on a user device (e.g., user device 140 of FIG. 1).

In operation 220, a request may be received to change the first set of media objects to a second set of media objects to be displayed in the broadcast. Such requests may be received iteratively, from the broadcast server, for example, each time a media object is added, deleted, replaced, and/or swapped.

In operation 230, a second layout may be selected from among a plurality of different candidate layout designs. Each layout may be predefined to display a different set of media objects. The new layout may be selected that is predefined to display the second set of media objects (e.g., according to map 117 of FIG. 1).

In operation 240, the broadcast may display the second set of media objects in the broadcast with the new layout design (e.g., on user output device 144 of FIG. 1).

Other operations of orders of operations may be used.

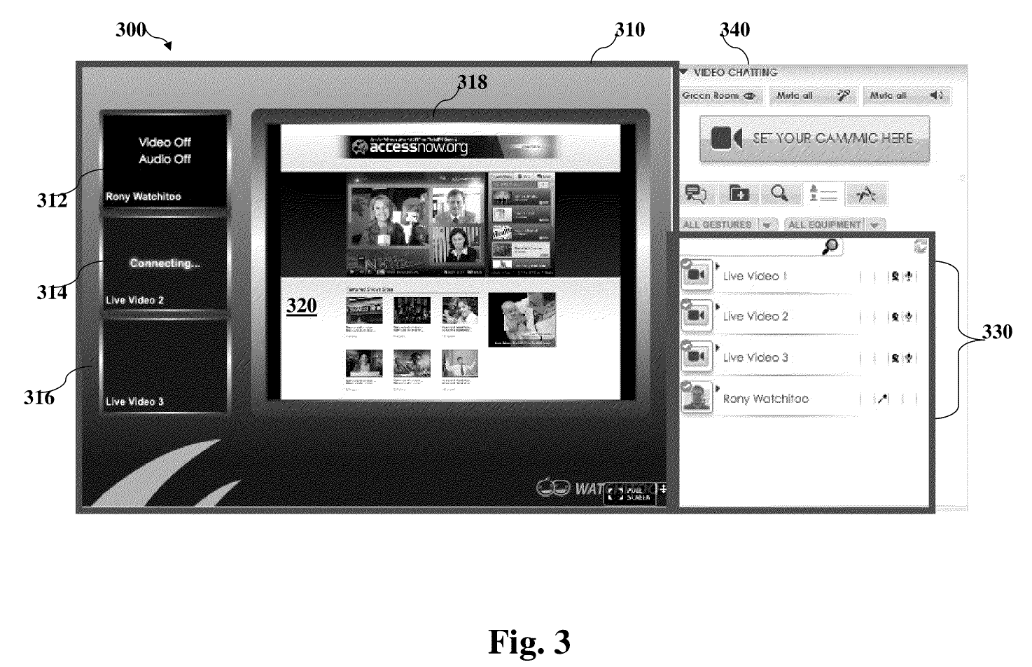

Reference is made to FIGS. 3-6, which are examples of layout interfaces 300-600 for operating a system and method for automatic and dynamic layout design in accordance with an embodiment of the invention. Layout interfaces 300-600 may be controlled by a client to design a broadcast, for example, via client device 150 of FIG. 1.

FIG. 3 shows one embodiment of a broadcast producer's display 300 including a broadcast screen interface 310, a staging screen interface 320, a media database interface 330, and a set of controls 340 to operate the interfaces. One or more input media objects 312-318 may be selected for broadcast, for example, via media database interface 330. Broadcast screen interface 310 may simulate a broadcast of input media objects 312-318 using one of a plurality of stored layouts predefined to display media objects having the same or similar media parameters or identifiers as input media objects 312-318.

Staging screen interface 320 may simulate a potential broadcast, which may, for example, only be displayed if a broadcast command is set. Staging screen interface 320 may include a different set of input media objects than broadcast screen interface 310 and therefore, may select a different corresponding layout predefined to display the different media objects.

Media database interface 330 may represent media objects (e.g., via icons or thumbnails) from which the client may select, add, delete, replace, swap, or otherwise manipulate for broadcast in broadcast screen interface 310 or staging screen interface 320. A user create or adapt the media database by adding, uploading, editing or otherwise manipulating the source media objects available to media database interface 330.

In one embodiment, controls 340 may allow the broadcaster to switch back and forth between displaying and interacting with broadcast screen interface 310 and staging screen interface 320. In one example, staging screen interface 320 may be embedded within broadcast screen interface 310 or vice versa (e.g., and the embedded screen may be changed by controls 340).

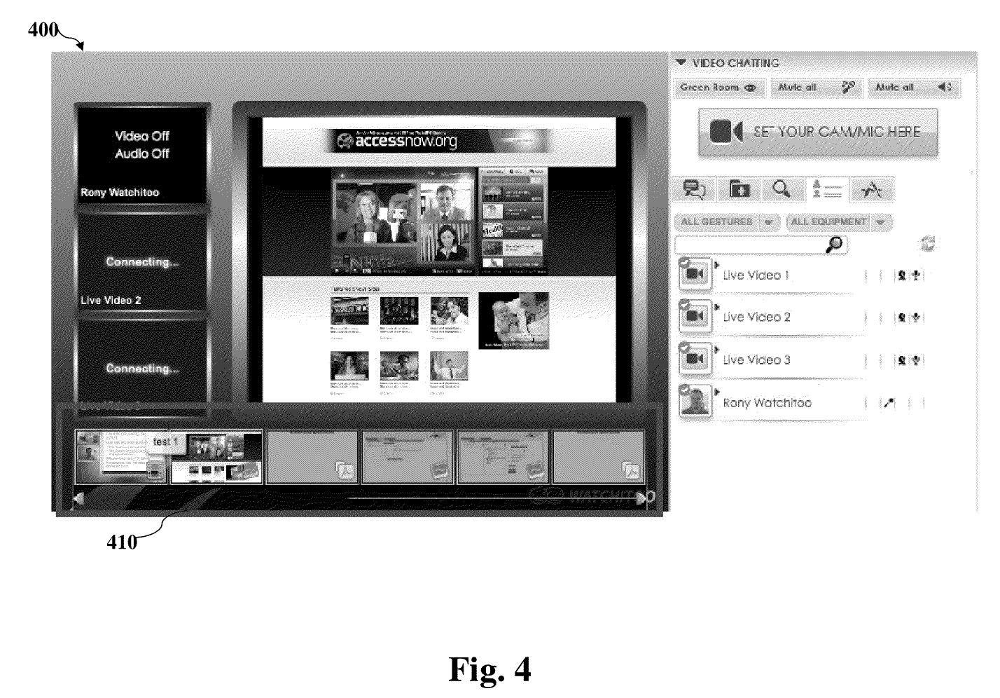

FIG. 4 shows another embodiment of a broadcast producer's display 400 (e.g., such as display 300 of FIG. 3) including a test broadcast interface 410 to view the entire broadcast over time. Test broadcast interface 410 may include snapshots of each different layout design displayed, in sequence.

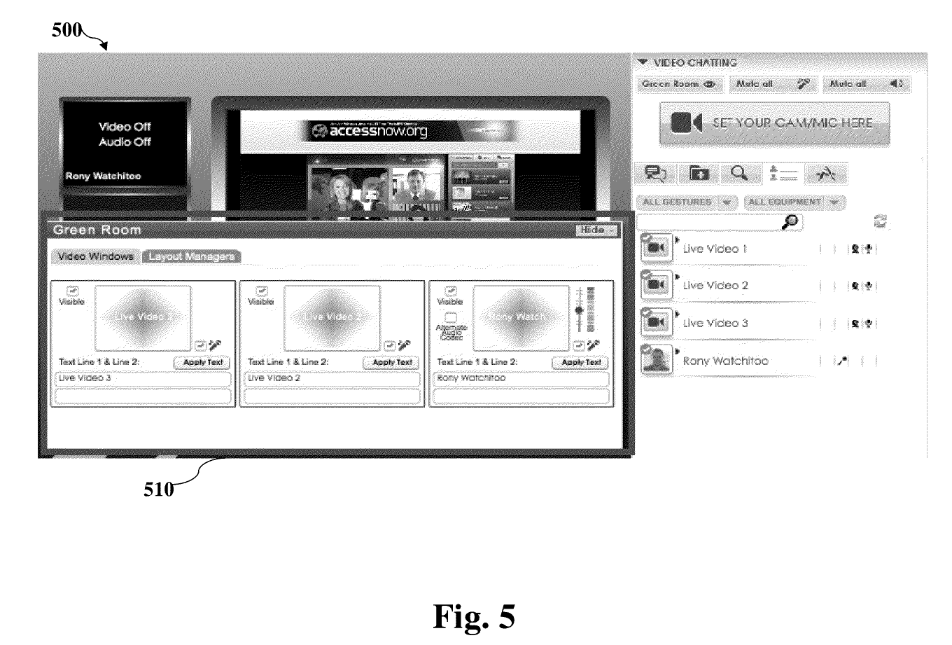

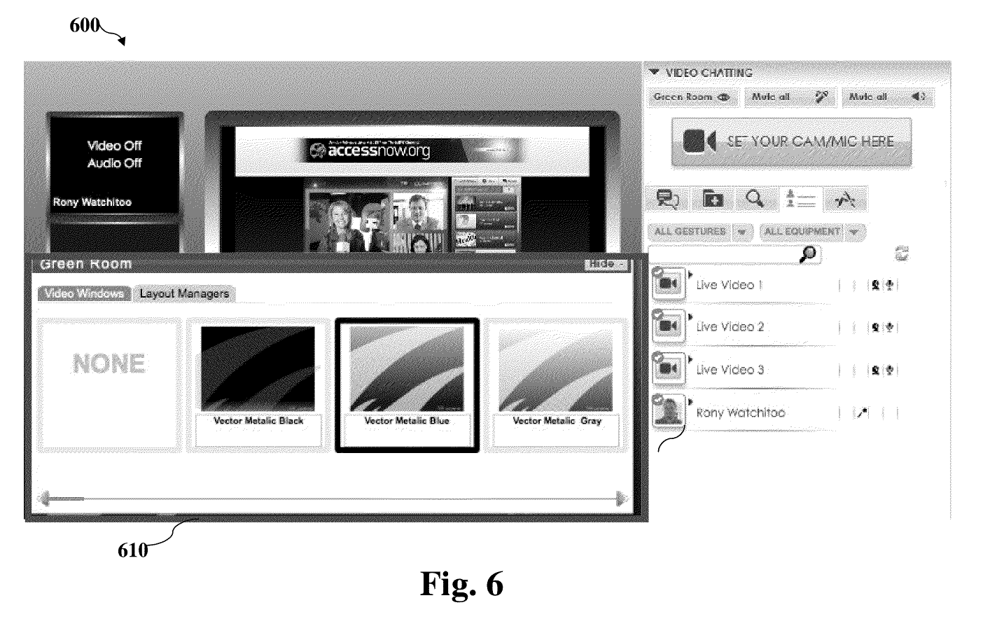

FIGS. 5 and 6 show further embodiments of a broadcast producer's displays 500 and 600 (e.g., such as display 300 of FIG. 3) including expanded staging or “green room” interfaces 510 and 610, respectively, to prepare and stage potential broadcasts. FIG. 5 shows a broadcast manager staging interface 510 for preparing the content or media input layer of a broadcast, showing the various media windows available for broadcast, and FIG. 6 shows a layout manager staging interface 610 for preparing a background or design layer of the broadcast.

Other interfaces or controls may be used.

The following terms are defined, for example, as follows:

Combination Format Option 1—[Tag 1, Contained1], [Tag2, Container2], [Tag3, Container3], . . . ; Option 2—[number of, Tag1], [number of, Tag2], [number of, Tag3], . . . .

Object: Object may be identified by a Tag name such as—Presentation, Webcam, LiveVideo, LetterDocument, . . . . Object may include content displayed via a container

Container: A container may be a window defined by a layout that displays an output of the object it binds. The layout may define one or more containers. Each container may be defined by a position on a Stage Area, dimensions, Aspect Ratio, Transition, and/or other properties that affects its behavior.

Layout: Layout may define one or more containers, background and foreground layers.

Theme: Theme may define a collection of layouts.

The following pseudo-code defines an example of an algorithm for adding an object to a broadcast according to one embodiment of the invention.

//Add the new Object that was dragged to Stage Area to the old
combination
NewCombination = OldCombination + NewObject:
//Find the new layout that fit the new combination
If (NewLayout=FindLayout(NewCombination))

{
//Bind the object to the free container in the new layout
NewContainersList = BindContainer(OldContainersList,

NewLayout, NewObject);

//Display the new layout
DisplayLayout(NewContainersList);
}

else

{
//Display an error message
ErrorMessage( );
}

The following pseudo-code defines an example algorithm for deleting an object from a broadcast according to one embodiment of the invention.

//Delete the object from the old combination
NewCombination = OldCombination − DeletedObject:
//Search for a new layout that fit the new combination
If (NewLayout=FindLayout(NewCombination))

{
//Use the function ShiftObjectUp to delete the object from the

container list

//and shift the remaining object's reference number up by one
NewContainersList = ShiftObjectsUp(OldContainerList,

NewLayout, DeletedObject);

DisplayLayout(NewContainersList);
}

else

{
ErrorMessage( );
}

The following pseudo-code defines an example algorithm for swapping objects in a broadcast according to one embodiment of the invention.

//Swapped containers numbers of the two object to get a new combination
NewCombination = SwappedCombination(OldCombination , Object1,
Object2):
//Find a new layout that match the new combination
If (NewLayout=FindLayout(NewCombination))

{
//Use the SwapObjects function to swap objects between the

containers

NewContainersList = SwapObjects(OldContainerList, NewLayout,

Obect1, Object2);

DisplayLayout(NewContainersList);
}

else

{
NewContainersList = SwapObjects(OldContainerList, OldLayout,

Object1, Object2);

DisplayLayout(NewContainersList);
}

The following pseudo-code defines an example algorithm for replacing objects in a broadcast according to one embodiment of the invention.

//Replacing an object1 with Object2 will result in replacing Object1 and
deleting //Object2 the old combination (if exists there) to form a new
combination
NewCombination = ReplaceCombination(OldCombination , Object1,
Object2):
If (NewLayout=FindLayout(NewCombination))

{
//Using the function ReplaceObjects we replace obect1 with

object2,

//delete Obeject2 from its container and bump all other objects up

to

//to fill up the empty container
NewContainersList = ReplaceObjects(OldContainerList,

NewLayout, Object1, Object2);

DisplayLayout(NewContainersList);
}

else

{
ErrorMessage( );
}

Other or different algorithms and operations may be used.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller (for example, processor(s) 116, 146, and 156, of FIG. 1), to carry out methods disclosed herein.

Although the particular embodiments shown and described above will prove to be useful for the many distribution systems to which the present invention pertains, further modifications of the present invention will occur to persons skilled in the art. All such modifications are deemed to be within the scope and spirit of the present invention as defined by the appended claims.

1. A method for automatic layout design, the method comprising:
displaying a first set of media objects in a broadcast within a first layout;
receiving a request to change the first set of media objects to a second set of media objects to be displayed in the broadcast;
selecting a second layout from among a plurality of different candidate layouts, wherein each of said different candidate layouts is predefined to display a different set of media objects, wherein the second layout is predefined to display the second set of media objects; and
displaying the second set of media objects in the broadcast within the second layout.

2. The method of claim 1, wherein each of said different candidate layouts has a number of windows appropriate to display that number of media objects.

3. The method of claim 1, wherein the second set of media objects has media objects that have been added, deleted, swapped or replaced from the first set of media objects.

4. The method of claim 3, wherein the second layout has media windows that have been added, deleted or replaced from the first layout in accordance with the media objects that have been added, deleted, swapped or replaced, respectively, in the second set of media objects from the first set of media objects.

5. The method of claim 1, wherein the request includes a set of input media parameters defining the type and size of each additional media object to be displayed.

6. The method of claim 1, wherein the second layout is selected using a map defining correspondences between layouts and media objects.

7. The method of claim 1, wherein the request includes a set of input media parameters defining a predefined media group of each additional media object to be displayed.

8. The method of claim 1, wherein the second layout is selected using a map defining correspondences between layouts and media groups.

9. The method of claim 1, wherein the displayed layout is switched from the first layout to the second layout in real-time.

10. The method of claim 1, wherein the broadcast is an Internet broadcast.

11. A system for automatic layout design, the system comprising:
a display to display a first set of media objects in a broadcast within a first layout;
a processor to receive a request to change the first set of media objects to a second set of media objects to be displayed in the broadcast on the display;
a memory to store a plurality of different candidate layouts each predefined to display a different set of media objects, wherein the processor is to select a second layout predefined to display the second set of media objects from among the plurality of different candidate layouts in the memory, and wherein the display is to display the second set of media objects in the broadcast within the second layout.

12. The system of claim 11, wherein each of said different candidate layouts stored in the memory has a number of windows appropriate to display that number of media objects.

13. The system of claim 11, wherein the second set of media objects stored in the memory has media objects that have been added, deleted, swapped or replaced from the first set of media objects.

14. The system of claim 13, wherein the second layout stored in the memory has media windows that have been added, deleted or replaced from the first layout in accordance with the media objects that have been added, deleted, swapped or replaced, respectively, in the second set of media objects from the first set of media objects.

15. The system of claim 11, wherein the request includes a set of input media parameters defining the type and size of each additional media object to be displayed.

16. The system of claim 11, wherein the processor selects the second layout using a map defining correspondences between layouts and media objects.

17. The system of claim 11, wherein the request includes a set of input media parameters defining a predefined media group of each additional media object to be displayed.

18. The system of claim 11, wherein the processor selects the second layout using a map defining correspondences between layouts and media groups.

19. The system of claim 11, wherein the processor switches the displayed layout from the first layout to the second layout in real-time.

20. The system of claim 11, wherein the broadcast is an Internet broadcast.
